(19) United States
(12) Patent Application Publication
(10) Pub. No.: US 2017/0234496 A1
(43) Pub. Date: Aug. 17, 2017

(54) FLAME SIMULATION APPARATUS

(71) Applicant: EI Shenzhen Limited, SHENZHEN (CN)

(72) Inventor: DEFA WANG, SHENZHEN (CN)

(21) Appl. No.: 15/583,831

(22) Filed: May 1, 2017

Related U.S. Application Data
(63) Continuation of application No. PCT/CN2015/073169, filed on Feb. 16, 2015.

(30) Foreign Application Priority Data
Feb. 6, 2015 (CN) 201520084556.3

(51) Int. Cl. F21S 10/04; F21V 14/06; F21S 6/00

(52) U.S. Cl. CPC F21S 10/046; F21S 6/001; F21V 14/06; F21Y 2115/10

(57) ABSTRACT

A flame simulation apparatus includes: a housing having an assembly chamber; a support in the chamber, having a fixed shaft with two ends respectively fastened to an optical assembly and a swing assembly; an LED assembly in the chamber, having a light emitting surface facing the optical assembly; a projection assembly having one end fixed inside the chamber and the other opposing end provided outside the housing; and an electromagnetic assembly, held at a bottom of the chamber, for generating magnetic field when energized. The electromagnetic assembly operates with the swing assembly to drive the support and the optical assembly thereon to swing back and forth around the fixed shaft as a rotation center. Light emitted by the LED assembly is projected on the projection assembly through the swinging optical assembly. The apparatus may simulate burning flames, increase swinging reliability, prevent stuck phenomenon, and involve simple structures and easy assembling.

### CROSS-REFERENCE TO RELATED APPLICATIONS

This application is a continuation of International Patent Application No. PCT/CN2015/073169 with a filing date of Feb. 16, 2015, designating the United States, now pending, and further claims priority to Chinese Patent Application No. 201520084556.3 with a filing date of Feb. 6, 2015, designating the United States, now pending. The content of the aforementioned applications, including any intervening amendments thereto, are incorporated herein by reference.

### TECHNICAL FIELD

The present invention relates to a technical field of daily used necessities, and more particularly, relates to a flame simulation apparatus.

### BACKGROUND OF THE PRESENT INVENTION

From the ancient time to nowadays, the invention of candles on the ancient human life at night plays an important role in improving the ancient human life quality at night. Since the appearance of candles, people basically have liberated from the “night torch lighting” mode, and thus not only the liberation of the hands is achieved, but also people's night activities are facilitated. With the era development, the candles have more and more diversified types, shapes and use ranges, people accordingly have more choices, and therefore candles progressively step into their glorious period, and while this period gradually came to an end after Edison invented the first practical bulb in the year of 1879, and after completely replaced by the bumble, the candle gradually withdrew from the historical arena.

However, modern people are still attracted by the flame and shape of the candle, and hope that the candles may remain in their daily life. In view of this emotional needs and a huge market demand, combined with the modern LED bulb technology, a product called electronic candle lights emerge as the times require. Electronic candle lamp, as the term suggests, means assembly of a simulated candle shell and a LED lamp received therein, and simulates the scene of real candles burning. Because of the features of safety, environmental protection, energy saving, elegance, and warmth, electronic candle lamp has been a first choice of lamp for a lot of places to prepare atmosphere, such as: cafe, restaurant, hotel, and home, particularly in Europe and America.

Throughout the candle lamp market, a variety of electronic candle lamps may be found, while product quality is uneven, and the technical content varies in different levels. After comparison, many products have the following shortcomings.

1. Simulation effects of flame film burning are not realistic enough. Most of the present candle lamps on the market achieve the effect of candle burning by the flame film swinging, but a stable kinetic energy system is essential in this design, and a little coordination in the internal parts will affect the flame swinging effect.

2. A high product power consumption, and a short usage lifetime are involved.

3. When the swinging movement reaches to two ends of the flame flake, stuck phenomenon is prone to occur. As the effect of candle burning is achieved by the flame film movement, stuck phenomenon is very easy to occur, when the flame film movement reaches to two ends, and a re-adjusting process is needed before the continue use.

4. Flame film is easily damaged. As the effect of candle burning of the products on the market is mostly achieved through shaking motion of the flame film. It is not suitable for windy places, such as places near air conditioners, near fans and in open air, etc., or otherwise the flame film moving frequency, simulating effects and usage lifetime will get affected.

### SUMMARY OF PRESENT INVENTION

The technical problem to solve in the present invention is to provide a flame simulation apparatus, which is capable of simulating the effect of flame burning, improving the reliability of the swinging, and avoiding stuck phenomenon, involves a simple structure and may be easy to assemble.

In order to solve the above technical problem, an embodiment of the present invention provides a flame simulation apparatus, comprising: a housing with a mounting chamber provided therein; a support mounted in the mounting chamber and having a fixed shaft, two ends of the fixed shaft respectively fastened to an optical assembly and a swing assembly; an LED assembly mounted in the assembly chamber and having a light emitting surface facing the optical assembly; a projection assembly, having a first end fixed inside the assembly chamber and a second end opposite to the first end, provided outside the housing; and an electromagnetic assembly, held at a bottom of the assembly chamber and configured to generate a magnetic field in an electrifying state, wherein, the electromagnetic assembly operates with the swing assembly to drive the support and the optical assembly thereon to swing back and forth around the fixed shaft acting as a swing center. Light emitted by the LED assembly passes through the swinging optical assembly to get projected on the projection assembly.

In one aspect, the projection assembly is a curved flake having a certain degree of curvature.

In another aspect, the mounting chamber has a bottom provided with a buckle for holding the electromagnetic assembly, and the electromagnetic assembly is held on the bottom of the mounting chamber by the buckle.

In a further aspect, the optical assembly is a lens, the swing assembly includes a weight and a magnet, with one end of the support connected to the lens, the weight is connected to the other end of the support opposite to the lens, and the magnet is fastened to the weight.

The flame simulation apparatus provided by the invention has the following beneficial effects.

Firstly, as the electromagnetic assembly operates with the swing assembly to drive the support and the optical assembly thereon to swing back and forth around the fixed shaft acting as a swing center, and light emitted by the LED assembly passes through the swinging optical assembly to get projected on the projection assembly, the flame simulation apparatus is able to simulate the flame burning effect, achieve realistic effects, and benefit to energy saving and environmental protection.

Secondly, since the projection assembly is a curved flake having a certain degree of curvature, the external force does not affect the optical assembly and the swing assembly inside the flame simulation apparatus, thus increasing reliability of swinging motion, and preventing swinging motion from being stopped.

Thirdly, the flame simulation apparatus has an accurate and simple structure, is easy to assemble, and facilitates costs controlling.

### DESCRIPTION OF THE DRAWINGS

In order to more clearly illustrate the embodiments of the present invention or the technical solutions in the prior art, the following drawings, which are to be used in the description of the embodiments or the prior art, will be briefly described below. Apparently, the drawings in the following description are just some of the embodiments for the present invention, and for those skilled in the art, other drawings may be obtained on the basis of the following FIGURE, without any inventive work.

FIG. 1 is a schematic view showing an internal structure of a flame simulation apparatus according to an embodiment of the present invention.

### DETAILED DESCRIPTION OF PREFERRED EMBODIMENTS

The technical solution in the embodiments of the present invention will now be clearly described with reference to the accompanying drawings in the embodiments of the present invention, and it will be apparent that the described embodiments are only a part of the embodiments of the invention and are not intended to limit all the embodiments. All other embodiments obtained by those of ordinary skill in the art without creative work should fall into the scope of the present invention, on the basis of the embodiments in the present invention.

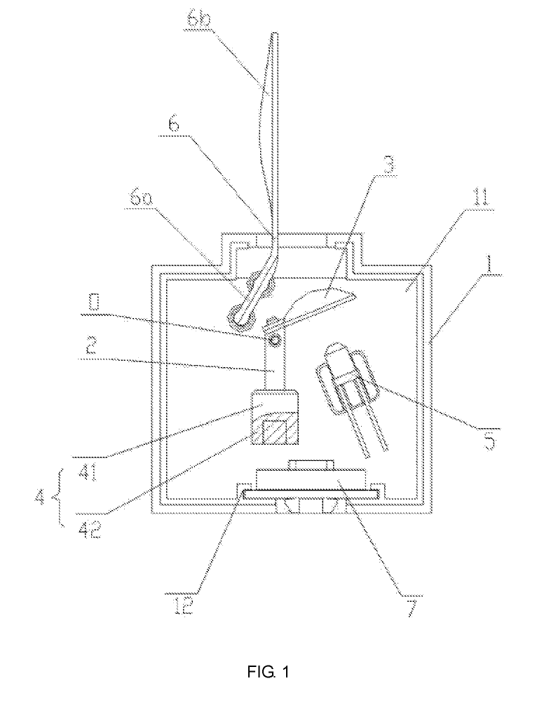

Referring to FIG. 1, a first embodiment of the flame simulation apparatus of the present invention is illustrated.

As shown in FIG. 1, the flame simulation apparatus in the present embodiment includes following configurations.

A housing 1 is included, and a mounting chamber 11 is provided in the housing 1. The housing 1 in this embodiment is in a cubic shape, and the shape may be adjusted according to practical needs. A bottom of the mounting chamber 11 is provided with a buckle 12 which includes two hooks opposite to each other for holding components mounted thereon. The top of the mounting chamber 11 is provided with an open end for making an access for the components of the flame simulation apparatus to extend from the inside to the outside, so as to realize the assembly function.

Further, a support 2 is fixed in the mounting chamber 11, and the support 2 has a fixed shaft O, the support 2 may rotates about the fixed rotary shaft O and an optical assembly 3 and a swing assembly 4 are respectively fastened at two ends of the support 2.

In the present embodiment, the optical assembly 3 is a lens, and two opposite sides of the lens are convex and planar, respectively.

The swing assembly 4 includes a weight 41 and a magnet 42 in the present embodiment, wherein the lens is attached to one end of the support 2, while the weight 41 is connected to the other end opposite to the lens, and the magnet 42 is fastened to the weight 41.

Further, an LED assembly 5 is included, i.e. a light emitting diode, mounted in the mounting chamber 11. The LED assembly in this embodiment has a light emitting surface facing the planar side of the lens.

Further, a projection assembly 6 is included, the projection assembly in the present embodiment having two opposite end portions 6a, 6b, including a first end portion 6a being rod-shaped, fixed in the interior of the assembly chamber 11, and a second end portion 6b opposite thereto which is a flake in shape of a flame, positioned on outside of the housing 1. In the present embodiment, the projection assembly is configures to be a curved flake having a certain degree of curvature, making the simulation effect of flame burning more realistic.

Moreover, an electromagnetic assembly 7 is included, which is held at the bottom of the mounting chamber 11 for generating a magnetic field in the electrifying state. In the present embodiment, the electromagnetic assembly 7 is a coil capable of generating a magnetic field in an electrifying state, and is held on the buckle 12 at the bottom of the fitting cavity 11. After assembly, the coil is located below the magnet 42 of the swing assembly 4.

During operation of the flame simulation apparatus in the embodiment, when the electromagnetic assembly 7 (coil) is energized, then generates a magnetic field, and further generates a magnetic force with the magnet 42 on the weight 41. The electromagnetic assembly 7 operates with the swing assembly 4 to drive the support 2 and the optical assembly 3 thereon to swing back and forth around the fixed shaft O acting as a swing center, and thus the light emitted from the LED module 5 (light emitting diode) passes through the swinging optical assembly 3 (lens) to be projected onto the projection assembly 6 (flame flake), thus achieving the simulation of a fantastic flame burning effect.

In other embodiments of the flame simulation apparatus of the present invention, the way of interacting motion between the electromagnetic assembly 7 and the swing assembly 4 may also be other means for supplying energy of motion and does not affect the implementation. The interacting motion between the electromagnetic assembly 7 and the swing assembly 4 may also be applied to the LED assembly 5, for example, keeping the optical assembly 3 stationary, the LED assembly 5 swings back and forth. That is, any manner in which the optical assembly 3 is used or projection assembly 6 is kept stationary to achieve the simulated flame burning effect, should all fall into the protection scope of the present invention, for example, the lens mounting position, size, material, swing frequency, etc. At the same time, the projection assembly 6 may also have a flake structure of other size or color.

The flame simulation apparatus of the present invention has the following advantageous effects.

Firstly, as the electromagnetic assembly operates with the swing assembly act to drive the support and the optical assembly thereon to swing back and forth around the fixed shaft acting as a swing center, and the light emitted by the LED assembly passes through the swinging optical assembly to be projected on the projection assembly, so as to simulate the flame burning effect, achieving a more realistic simulation effect. The flame simulation apparatus may be used as an atmosphere lamp, involving not only a good appearance and elegance, but also a better practicability, thus becomes a first choice of lamp to prepare atmosphere for a lot of places, such as cafe, restaurant, hotel, and home, etc., and has a low power consumption, a longer usage period, benefiting to energy saving and environmental protection.

Secondly, since the projection assembly is a flake having a certain degree of curvature, the external force may not affect the optical assembly and the swing assembly inside the flame simulation apparatus, and thus the reliability of the swinging motion may be improved and stuck phenomenon may be avoided. For example, external forces generated by wind, fans, and air conditioner will not affect the swinging motion, and therefore, the flame simulation apparatus may be a good outdoor lamp for atmosphere preparation.

Thirdly, the flame simulation apparatus has an accurate and simple structure, is easy to assemble, and facilitates costs controlling.

The disclosure only describes the preferred embodiments of the present invention, and certainly is not intended to limit the scope of the invention. Therefore, any equivalences and modifications should still fall into the scope of the present invention.

I claim:

1. A flame simulation apparatus comprising:
a housing, in which a mounting chamber is provided;
a support mounted in the mounting chamber and having a fixed shaft, two ends of the fixed shaft respectively fastened to an optical assembly and a swing assembly;
an LED assembly mounted in the assembly chamber and having a light emitting surface facing the optical assembly;
a projection assembly, having a first end fixed inside the assembly chamber and a second end opposite to the first end and provided outside the housing;
and an electromagnetic assembly, held at a bottom of the assembly chamber and configured to generate a magnetic field in an electrifying state,
wherein, the electromagnetic assembly operates with the swing assembly to drive the support and the optical assembly thereon to swing back and forth around the fixed shaft acting as a swing center, and light emitted by the LED assembly passes through the swinging optical assembly to get projected on the projection assembly.

2. The flame simulation apparatus according to claim 1, wherein the projection assembly is a curved flake having a certain degree of curvature.

3. The flame simulation apparatus according to claim 1, wherein the mounting chamber has a bottom provided with a buckle for holding the electromagnetic assembly, and the electromagnetic assembly is held on the bottom of the mounting chamber by the buckle.

4. The flame simulation apparatus according to claim 1, wherein, the optical assembly is a lens, the swing assembly includes a weight and a magnet, and with one end of the support connected to the lens, the weight is connected to the other end of the support opposite to the lens, and the magnet is fastened to the weight.
